(19) United States
(12) Patent Application Publication
(10) Pub. No.: US 2006/0114242 A1
(43) Pub. Date: Jun. 1, 2006

(54) Detection method of touch-panel device

(75) Inventor: Yi-Chan Lin, Hsinchu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Holtek Semiconductor Inc., Hsinchu (TW)

(21) Appl. No.: 11/281,850

(22) Filed: Nov. 17, 2005

(30) Foreign Application Priority Data
Nov. 29, 2004 (TW) 093136802

(51) Int. Cl. G09G 5/00

(52) U.S. Cl. 345/173

(57) ABSTRACT

A detection method for a touch-panel device having a touch pad electrically connected to at least m×n equivalent capacitors is provided, wherein m is a number of the equivalent capacitors on a specific one of rows and n is a number of the equivalent capacitors on a specific one of columns. The method includes steps of: (a) charging the m equivalent capacitors on the specific row to obtain m digital signals; (b) comparing potentials of the m digital signals and obtaining a relatively smallest potential as a standard value; (c) repeating the steps (a)˜(b) to obtain n the standard values for the m×n equivalent capacitors; (d) touching the touch pad; (e) scanning the touch pad to obtain at least a potential variation value relative to the standard value for the m equivalent capacitors on the specific row; and (f) comparing the standard value with the variation value to identify a touched point on the touch pad.

### FIELD OF INVENTION

The present invention relates to a detection method for a touch-panel device. In particular, the present invention relates to a detection method for a capacitive touch-panel device.

### BACKGROUND

Generally, a touch-panel device is operated with a resistive system or a capacitive system. For the capacitive touch-panel device, three detecting methods are adopted as follows.

(1) The potential of a touch-pad is stored and then compared with charging potential of all touch-pads so that the touched touch-pad is able to be detected by a MCU.

Firstly, a standard-potential-value storing step is proceeded in the MCU. A pulse train is provided to one terminal of an equivalent capacitor of the touch-panel, and a charge energy is induced in the other terminal of the equivalent capacitor. The charge is then stored in the equivalent capacitor through an integrator, and the charging potential of the equivalent capacitor is amplified by an amplifier. The amplified charging potential is converted into a digital signal through an A/D circuit and is stored in a memory. Finally, all touch-pads are scanned. The A/D output signal of every touch-pad of the touch-panel is compared with the signal in the memory. When the A/D output signal greater than the signal in the memory is detected, the touch-pad which was touched will be identified.

However, if the thickness of the substrate is different from that of the copper foil, the capacitance of the equivalent capacitor of every touch-pad will also be different. The inaccuracy also occurs frequently while the comparison is proceeded.

(2) Charging potential of all touch-pads is averaged, and then the averaged value is compared with charging potential of all touch-pads so that the touched touch-pad is able to be detected by a MCU.

When the standard-potential-value storing step is proceeded, the potential values of the equivalent capacitors of all touch-pads are averaged. The averaged value is then stored in the memory. Then all touch-pad are scanned. Each of the potential values of all touch-pad integrated capacitors is compared with the standard potential value. When the potential value smaller than the standard potential value is detected, the touch-pad which was touched will be identified.

(3) Charging potential of all touch-pads are stored and then compared with the originally stored potential respectively, and the touched touch-pad is detected if the charging potential thereof is smaller than the originally stored potential.

When the standard-potential-value storing step is proceeded, all integrated capacitor potential values of all touch-pads are stored. After the touch-pads are scanned, the scanned integrated capacitor potential value of one touch-pad is compared with a standard integrated capacitor potential value. The touched touch-pad is detected if the scanned integrated capacitor potential value is smaller than the standard integrated capacitor potential value.

Among the aforementioned three methods, the quantity of the memory used in the first and the second methods is small. However, the detecting range and sensitivity will be decreased as the quantity of the touch-pads is increased. The equivalent capacitances of the touch-pads in the touch-panel vary with the material of the substrate, the thickness of the substrate, and the thickness of the copper foil. When the charged potential of each touch-pad is compared with the originally stored potential, the judgment of the detection is likely to be made inaccurately. Besides, the detection is also subject to the external factors easily.

The third method is able to improve the detecting range and sensitivity. However, the need for the memory space is increased considerably when the quantity of the touch-pads is large. Besides, the higher the bit of the A/D circuit in the touch-panel device is, the more the need for the memory space will be. Hence, the operation speed of the touch-panel device slows down due to the mentioned two factors.

It is therefore attempted by the applicant to deal with the above situation encountered in the prior art.

### SUMMARY

According to one aspect of the present invention, the detecting range and sensitivity of the capacitive touch-panel device is improved.

According to another aspect of the present invention, the need for the memory space is decreased and the operation speed of the MCU slows down by obtaining the pad with the lowest integrated capacitor potential on the X-rows of the matrix, so that the detecting range and sensitivity of the capacitive touch-panel device is improved.

According to further another aspect of the present invention, potential of all touch-pads on every X-row are compared with each other to obtain a touch-pad with the lowest potential value when the standard-potential-value storing step is proceeded. Then the lowest potential is stored into the memory. After all touch-pads are scanned, the potential of each X-row is compared with the standard potential value. The touched touch-pad is detected if the detected potential is smaller than the standard potential value.

According to further another aspect of the present invention, a detection method for a touch-panel device having a touch pad electrically connected to at least m ×n equivalent capacitors is provided, wherein m is a number of the equivalent capacitors on a specific one of rows and n is a number of the equivalent capacitors on a specific one of columns. The method includes steps of: (a) charging the m equivalent capacitors on the specific row to obtain m digital signals; (b) comparing potentials of the m digital signals and obtaining a relatively smallest potential as a standard value; (c) repeating the steps (a)˜(b) to obtain n the standard values for the m×n equivalent capacitors; (d) touching the touch pad; (e) scanning the touch pad to obtain at least a potential variation value relative to the standard value for the m equivalent capacitors on the specific row; and (f) comparing the standard value with the variation value to identify a touched point on the touch pad.

According to further another aspect of the present invention, a detection method for a touch-panel device having m×n pads respectively electrically connected to capacitors is provided, wherein m is a number of the pads on a specific one of rows and n is a number of the pads on a specific one of columns. The method includes steps of: (a) charging the m capacitors on the specific row to obtain m digital signals; (b) comparing potentials of the m digital signals and obtaining a relatively smallest potential as a standard value; (c) repeating the steps (a)˜(b) to obtain n the standard values for the m×n capacitors; (d) touching the touch-panel device; (e) scanning the touch-panel device to obtain at least a variation value relative to the standard value for the m capacitors on the specific row; and (f) comparing the standard value with the variation value to identify a touched pad on the touch-panel device.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a structural diagram of a capacitive touch-panel device in accordance with a preferred embodiment of the present invention; and

FIG. 2 is a diagram showing the operation principle of the capacitive touch-panel device in FIG. 1.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

The operational principle of the present invention will be described as follows. A charging potential of a touch-pad on an X-row of a touch-panel device is stored as a standard potential value. The integrated capacitor potential value is a relatively lowest potential value among those of all touch-pads on the X-row. When some touch-pad on the X-row of the touch-panel is touched, the charge of the touch-pad will be attracted away. At this time, the charging potential of the touch-pad is definitely lower than the standard potential value. By detecting this situation, a MCU is able to identify the touch-pad being touched.

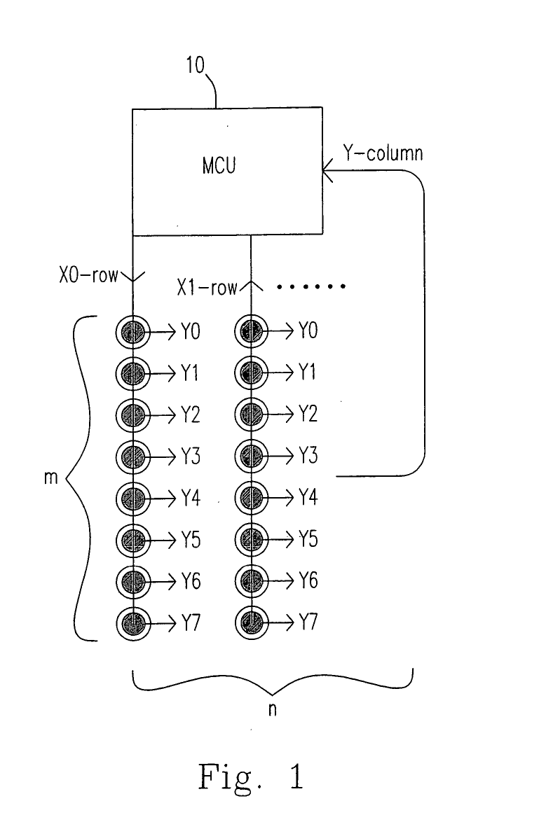

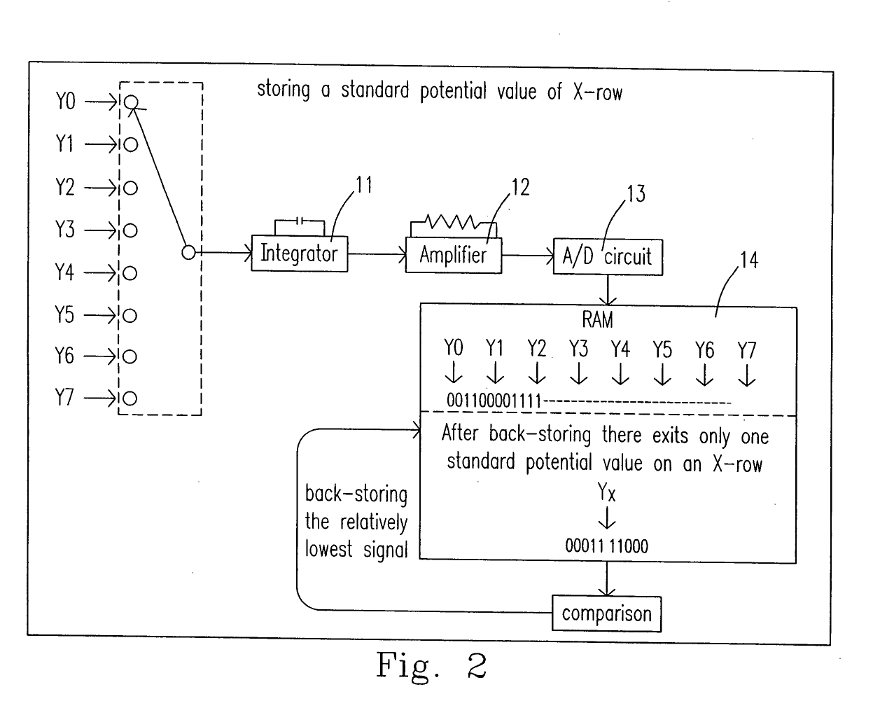

FIG. 1 is a structural diagram of a capacitive touch-panel device in accordance with a preferred embodiment of the present invention. The capacitive touch-panel is composed of m×n touch-pads. Each touch-pad is electrically connected to a real capacitor or an equivalent capacitor, wherein m is the number of the real or equivalent capacitors on a specific X-row and n is the number of the real or equivalent capacitors on a specific Y-column. FIG. 2 is a diagram showing the operation principle of the capacitive touch-panel device in FIG. 1. The present invention will be described in detail by referring to FIG. 1 and FIG. 2.

The control principle of the MCU 10 includes two steps:

(1) the step of storing the standard potential value; and (2) the step of scanning all touch-pads.

A. A first pulse train is outputted from an output terminal of the MCU 10 to m capacitors or equivalent capacitors on an X-row.

B. The first pulse train is then induced as a first energy through the capacitors or equivalent capacitors and stored in an integrator 11.

C. A first waveform outputted from the integrator 11 is inputted into an amplifier 12 to be amplified.

D. The output of the amplifier 12 is converted into a first digital signal by an A/D circuit 13 and stored in a memory 14.

E. All the other touch-pads on the X-row are scanned until the integrated capacitor potentials of all touch-pads on the X-row are converted into the digital signals. Then the integrated capacitor potentials are stored in the memory 14.

F. The digital signals of all touch-pads on the X-row are compared with each other to obtain the relatively lowest signal. The relatively lowest signal is then stored in the memory 14.

G. The relatively lowest signal is multiplied by a factor, e.g. 90% or 95%, and then stored in the memory 14 as a standard potential value for the following scanning. The first energy in the integrator 11 is then cleared. (The factor is used for the perfect control of the sensitivity. The lower the factor is set, the worse the sensitivity will be. However, the MCU 10 is prone to erroneous identification if the factor is too high. Therefore, the factor needs to be adjusted according to the operation situations of the external devices to achieve a relatively optimal level.)

H. The standard potential values of all capacitors on each X-row are stored in the memory 14, as shown in FIG. 2. The touch-panel is ready to be scanned after it is touched. (2) the step of scanning all touch-pads.

After the touch-pads or the touch-panel are touched, the step of scanning all touch-pads is proceeded. The procedure is also performed through the integrator 11, the amplifier 12, and the A/D circuit 13. The initial operations are the same with step A-step C.

I. A second pulse train is outputted from the output terminal of the MCU 10 to m capacitors or equivalent capacitors on the X-row.

J. The second pulse train is then induced as a second energy through the capacitors or equivalent capacitors and stored in the integrator 11.

K. A second waveform outputted from the integrator 11 is inputted into the amplifier 12 to be amplified.

L. The output of the amplifier 12 is converted into a second digital signal by the A/D circuit 13. The second digital signal stands for a potential variation value after the touch-pad or the touch-panel is touched.

The potential variation value is then compared with the standard potential value stored in the memory 14. If the potential variation value is lower than the standard potential value, which represents the touch-pad is touched, the MCU 10 sends out the coordinate of the touch-pad and continues scanning the next X-row. If the potential variation value is higher than the standard potential value, which represents the touch-pad is not touched, the MCU 10 continues scanning the next X-row.

In the present invention, the memory 14 is a random access memory (RAM). When the power supply of the device is cut off or reset, the MCU 10 must re-process and store the standard potential value.

In the embodiment, the memory 14 and the integrator 11 are implemented respectively outside the MCU 10. The object of the present invention is also able to be achieved by the integrator 11 and the memory 14 integrated in the MCU 10.

The detecting range and sensitivity of a capacitive touch-panel device is able to be improved by applying the detection method provided by the present invention. There are also variations in the pattern and the quantity of the touch-pads. The performance of the touch-panel device is not affected by the defective external electronic elements and the equivalent capacitors with inequable potential.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

1. A detection method for a touch-panel device having a touch pad electrically connected to at least m×n equivalent capacitors, wherein m is a number of said equivalent capacitors on a specific one of rows and n is a number of said equivalent capacitors on a specific one of columns, comprising steps of:
(a) charging said m equivalent capacitors on said specific row to obtain m digital signals;
(b) comparing potentials of said m digital signals and obtaining a relatively smallest potential as a standard value;
(c) repeating said steps (a)˜(b) to obtain n said standard values for said m ×n equivalent capacitors; (d) touching said touch pad;
(e) scanning said touch pad to obtain at least a potential variation value relative to said standard value for said m equivalent capacitors on said specific row; and
(f) comparing said standard value with said variation value to identify a touched point on said touch pad.

2. The detection method according to claim 1, wherein said touch-panel device further comprises an integrator and a memory, and said step (a) further comprises steps of:
providing said m equivalent capacitors with a first pulse as a first energy; saving said first energy in said integrator;
amplifying and converting a first output waveform of said integrator to a first digital signal; and
storing said first digital signal in said memory.

3. The detection method according to claim 2, wherein said step (b) further comprises a step of:
removing said first energy from said integrator.

4. The detection method according to claim 2, between said step (d) and said step (e) further comprising steps of:
Providing m said equivalent capacitors with a second pulse as a second energy;
saving said second energy in said integrator; and
amplifying and converting a second output waveform from said integrator to a second digital signal as said variation value.

5. The detection method according to claim 2, wherein said memory and said integrator are integrated in a micro controller unit (MCU).

6. The detection method according to claim 2, wherein said memory is a random access memory (RAM).

7. The detection method according to claim 2, wherein said step (b) further comprises steps of:
multiplying said relatively smallest first digital signal by a factor to obtain said standard value; and
storing said standard value in said memory.

8. The detection method according to claim 7, wherein said factor is determined by a user for adjusting a sensitivity of said touch pad.

9. The detection method according to claim 1, wherein said touch-panel device further comprises a micro controller unit (MCU) for controlling said steps.

10. A detection method for a touch-panel device having a touch pad electrically connected to a plurality of equivalent capacitors, comprising steps of:
(a) charging said equivalent capacitors to obtain digital signals;
(b) comparing potentials of said digital signals and obtaining a relatively smallest potential as a standard value;
(c) touching said touch pad;
(d) scanning said touch pad to obtain at least a variation value relative to said standard value for each of said equivalent capacitors; and
(e) comparing said standard value with said variation value to identify a touched point on said touch pad.

11. The detection method according to claim 10, wherein said touch-panel device further comprises an integrator and a memory, and said step (a) further comprises steps of:
providing a first pulse to each of said equivalent capacitors as a first energy;
saving said first energy in said integrator;
amplifying and converting a first output waveform from said integrator to a first digital signal; and
storing said first digital signal in said memory.

12. The detection method according to claim 11, wherein said step (b) further comprises steps of:
multiplying said relatively smallest first digital signal by a factor to obtain said standard value; and
storing said standard value in said memory.

13. The detection method according to claim 11, wherein said step (b) further comprises a step of:
removing said first energy from said integrator.

14. The detection method according to claim 11, between said step (c) and said step (d) further comprising steps of:
providing a second pulse to each of said equivalent capacitors as a second energy;
saving said second energy in said integrator; and
amplifying and converting a second output waveform from said integrator to a second digital signal as said variation value.

15. The detection method according to claim 11, wherein said memory and said integrator are integrated in a micro controller unit (MCU).

16. The detection method according to claim 11, wherein said memory is a random access memory (RAM).

17. The detection method according to claim 12, wherein said factor is determined by a user for adjusting a sensitivity of said touch pad.

18. The detection method according to claim 10, wherein said touch-panel device further comprises a micro controller unit (MCU) for controlling said steps.

19. A detection method for a touch-panel device having m×pads respectively electrically connected to capacitors, wherein m is a number of said pads on a specific one of rows and n is a number of said pads on a specific one of columns, comprising steps of:
(a) charging said m capacitors on said specific row to obtain m digital signals;
(b) comparing potentials of said m digital signals and obtaining a relatively smallest potential as a standard value;
(c) repeating said steps (a)˜(b) to obtain n said standard values for said m×n said capacitors;
(d) touching said touch-panel device;
(e) scanning said touch-panel device to obtain at least a variation value relative to said standard value for said m capacitors on said specific row; and
(f) comparing said standard value with said variation value to identify a touched pad on said touch-panel device.

20. A detection method for a touch-panel device having at least one pad electrically connected to a capacitor, comprising steps of:
charging said capacitor to obtain a digital signal;
detecting a potential of said digital signal and obtaining a potential as a standard value;
touching said touch-panel device;
scanning said touch-panel device to obtain at least a variation value relative to said standard value for said capacitor; and
comparing said standard value with said variation value to identify a touched pad on said touch-panel device.
